(19) United States
(12) Patent Application Publication
(10) Pub. No.: US 2023/0159378 A1
(43) Pub. Date: May 25, 2023

(54) COMPOSITIONS AND METHODS OF MAKING A GLASS-CERAMIC ARTICLE

(71) Applicant: Corning Incorporated, Corning, NY (US)

(72) Inventors: Qiang Fu, Painted Post, NY (US); Dmitri Vladislavovich Kuksenkov, Elmira, NY (US); Alana Marie Whittier, Painted Post, NY (US)

(21) Appl. No.: 17/919,078

(22) PCT Filed: Apr. 14, 2021
(86) PCT No.: PCT/US2021/027235

§ 371 Date: Oct. 14, 2022

Related U.S. Application Data
(60) Provisional application No. 63/017,326, filed on Apr. 29, 2020.

(51) Int. Cl. C03C 10/00

(52) U.S. Cl. CPC C03C 10/0018

(57) ABSTRACT

An optical diffuser can comprise an amorphous phase and a crystalline phase comprising lithium disilicate and one or more of ß-spodumene or ß-quartz comprising a median grain size ranging from about 500 nanometers to about 1,000 nanometers. The crystalline phase can be dispersed throughout a volume of the optical diffuser. The optical diffuser can comprise, on an oxide basis in mol %, SiO₂: 60-75; Al₂O₃: 2-9; Li₂O: 17-25; and Na₂O+K₂O: 0.5-6. Methods of making an optical diffuser can comprise forming a mixture by melting together, on an oxide basis in mol %, SiO₂: 60-75; Al₂O₃: 2-9; Li₂O: 17-25; and Na₂O+K₂O: 0.5-6. Methods can comprise forming a ribbon from the mixture. Methods can comprise heating the ribbon about 850° C. to about 900° C. for about 0.5 hours to about 6 hours.

This application claims priority under 35 USC § 119(e) from U.S. Provisional Patent Application Ser. No. 63/017,326 filed on Apr. 29, 2020, which is incorporated by reference herein in its entirety.

### FIELD

The present disclosure relates generally to compositions and methods of making a glass-ceramic article and, more particularly, to compositions and methods of making a glass-ceramic article comprising a lithium-aluminum-silica glass-ceramic article.

### BACKGROUND

Display devices include liquid crystal displays (LCDs), electrophoretic displays (EPD), organic light-emitting diode displays (OLEDs), plasma display panels (PDPs), or the like. Display devices can be part of a portable electronic device, for example, a consumer electronic product, a smartphone, a tablet, a wearable device, or a laptop.

Display devices often include illumination sources, for example, light-emitting diodes (LEDs). LEDs can provide very bright point light source that can appear harsh and/or cause glare when viewed directly. It is known to include a diffuser in display devices, for example, to hide optical defects and/or to improve the brightness uniformity from an illumination source.

It is known to manufacture diffusers from polymeric materials, for example, polycarbonate, polystyrene, and/or poly(methyl)methacrylate. However, polymeric materials can yellow over time, have poor thermal stability, and/or have poor dimensional stability.

Consequently, there is a need to develop a material that can be used as a diffuser with high transparency, high haze, and good hiding power. Further, there is a need to develop such materials with good thermal and/or dimensional stability and are not subject to yellowing over time.

### SUMMARY

There are set forth herein compositions and methods for making glass-ceramic articles. The compositions of the disclosure can simultaneously provide high light transmittance (e.g., about 40% or more, from about 40% to about 70%) and high haze (e.g., about 95% or more, from about 100% to about 105%). Providing a glass-ceramic article comprising high light transmittance and high haze can act as, for example, a diffuser that increases brightness uniformity while efficiently transmitting light. Efficiently transmitting light can increase illumination from a display device and decrease an amount of energy from an illumination source that is lost as heat, which can further increase stability of the display device.

Compositions of the embodiments of the disclosure can produce glass-ceramic articles comprising lithium disilicate crystals. Providing lithium disilicate crystals can increase the mechanical stability and mechanical strength of the glass-ceramic article. Providing substantially interlocking lithium disilicate crystals can further increase the mechanical stability and mechanical strength of the glass-ceramic article.

Compositions of the embodiments of the disclosure can produce glass-ceramic articles further comprising one or more of ß-spodumene or ß-quartz. Without wishing to be bound by theory, ß-spodumene or ß-quartz crystals can increase light scattering of the glass-ceramic article, which can increase the haze and hiding power of the glass-ceramic article. Further, providing a median grain size ranging from about 500 nanometers to about 1,000 nanometers (e.g., from 600 nanometers to about 800 nanometers) can increase scattering of visible light (e.g., from about 380 nanometers to about 740 nanometers, from about 400 nanometers to about 700 nanometers), which can increase the haze and hiding power of the glass-ceramic article for visible light.

Providing a glass-ceramic article comprising alkali-containing aluminosilicate and/or alkali-containing aluminoborosilicate compositions can facilitate formation of lithium disilicate, ß-spodumene, and/or ß-quartz crystals, which can be a solid solution. Alkali-containing aluminosilicate and/or alkali-containing aluminoborosilicate composition can provide good thermal and/or dimensional stability. Further, compositions comprising a high mole percent (mol %) on an oxide basis of lithium (e.g., about 17% or more, from about 20% to about 25%) and low aluminum (e.g., about 10% or less, from about 3% to about 9%) can promote formation of the above crystals. Providing a composition comprising phosphorous (e.g., from about 1 mol % to about 2 mol % on an oxide basis) can facilitate nucleation of such crystals.

Heating the compositions of the embodiments of the disclosure to a crystallizing temperature ranging from about 850° C. to about 900° C. can facilitate crystal formation and controlled crystal growth. Further, prior to heating the composition to the crystallizing temperature, heating the composition to a nucleating temperature ranging from about 550° C. to about 800° C. can increase the density of crystals and/or facilitate increase control in crystal growth. Providing a composition with a liquidus viscosity of about 80 Pascal-seconds or more and/or a liquidus temperature of about 1000° C. or more can facilitate processing of the glass-ceramic article and precursors.

Some example embodiments of the disclosure are described below with the understanding that any of the features of the various embodiments may be used alone or in combination with one another.

In some embodiments, an optical diffuser can comprise an amorphous phase and a crystalline phase. The crystalline phase can comprise lithium disilicate and one or more of ß-spodumene or ß-quartz comprising a median grain size ranging from about 500 nanometers to about 1,000 nanometers. The crystalline phase can be dispersed throughout a volume of the optical diffuser. The optical diffuser can comprise the following on an oxide basis in mol %: SiO₂: 60-75; Al₂O₃: 2-9; Li₂O: 17-25; and Na₂O+K₂O: 0.5-6.

In further embodiments, the optical diffuser can further comprise the following on an oxide basis in mol %: P₂O₅: 0.5-2; ZrO₂: 0.2-8; B₂O₃: 0-5; MgO+CaO+SrO: 0-5; ZnO: 0-2; and SnO₂: 0-2.

In even further embodiments, the optical diffuser can comprise the following on an oxide basis in mol %: SiO₂: 67-70; Al₂O₃: 2.5-4.5; LiO₂: 21-24; Na₂O: 0.5-2; K₂O: 0-1; P₂O₅: 1-2; ZrO₂: 1.5-4; and SnO₂: 0.1.

In further embodiments, ß-spodumene can be predominant.

In further embodiments, ß-quartz can be predominant.

In further embodiments, the median grain size can range from about 600 nanometers to about 800 nanometers.

In further embodiments, the lithium disilicate crystals can be substantially interlocked.

In further embodiments, the optical diffuser can further comprise a first major surface and a second major surface opposite the first major surface. A thickness defined between the first major surface and the second major surface can range from about 0.5 millimeters to about 5 millimeters.

In even further embodiments, the thickness of the optical diffuser can range from about 0.8 millimeters to about 1.5 millimeters.

In even further embodiments, the optical diffuser can comprise a light transmittance ranging from about 40% to about 70%.

In still further embodiments, the light transmittance of the optical diffuser can range from about 50% to about 60%.

In even further embodiments, the optical diffuser can comprise a haze of about 95% or more.

In still further embodiments, the haze of the optical diffuser can range from about 100% to about 105%.

In even further embodiments, the optical diffuser can comprise an integrated light transmission of about 40% or more.

In still further embodiments, the integrated light transmission of the optical diffuser can range from about 50% to about 70%.

In even further embodiments, the optical diffuser can comprise a hiding power of about 20 millimeters or less.

In still further embodiments, the hiding power of the optical diffuser can range from about 1 millimeter to about 10 millimeters.

In even further embodiments, the optical diffuser can comprise a color shift of about 0.2 or less.

In still further embodiments, the color shift of the optical diffuser can range from about −0.1 to about 0.1.

In further embodiments, a display device can comprise a light source. The display device can comprise the optical diffuser. The display device can comprise an image display device comprising a plurality of pixels. The optical diffuser can be positioned between the light source and the image display device.

In some embodiments, a method of making an optical diffuser can comprise forming a mixture by melting together the following on an oxide basis in mol %: SiO₂: 60-75; Al₂O₃: 2-9; Li₂O: 17-25; and Na₂O+K₂O: 0.5-6. The method can comprise forming a ribbon from the mixture. The ribbon can comprise a first major surface and a second major surface opposite the first major surface. The method can comprise heating the ribbon to a crystallizing temperature ranging from about 850° C. to about 900° C. for a crystallizing time ranging from about 0.5 hours to about 6 hours, wherein a crystalline phase comprising lithium disilicate and one or more of ß-spodumene or ß-quartz crystals comprising a median grain size ranging from about 500 nanometers to about 1,000 nanometers are formed as a result heating the ribbon to the crystallizing temperature. The crystalline phase can be dispersed throughout a volume of the optical diffuser.

In further embodiments, the method can further comprise heating the ribbon to a nucleating temperature ranging from about 550° C. to about 800° C. for a nucleating time ranging from about 0.5 hours to about 6 hours before heating the ribbon to the crystallizing temperature.

In further embodiments, the forming the ribbon can comprise rolling, slot drawing, or float drawings the mixture.

In further embodiments, the mixture can comprise a liquidus temperature ranging from about 1000° C. to about 1250° C.

In further embodiments, the mixture can comprise a liquidus viscosity ranging from about 800 Pascal-seconds (Pa-s) to about 1,000 Pa-s.

In even further embodiments, the liquidus viscosity can range from about 140 Pa-s to about 600 Pa-s.

In further embodiments, the mixture can further comprise the following on an oxide basis in mol %: P₂O₅: 0.5-2; ZrO₂: 0.2-8; B₂O₃: 0-5; MgO+CaO+SrO: 0-5; ZnO: 0-2; and SnO₂: 0-2.

In even further embodiments, the mixture can comprise the following on an oxide basis in mol %: SiO₂: 67-70; Al₂O₃: 2.5-4.5; LiO₂: 21-24; Na₂O: 0.5-2; K₂O: 0-1; P₂O₅: 1-2; ZrO₂: 1.5-4; and SnO₂: 0.1.

In further embodiments, ß-spodumene can be predominant.

In further embodiments, ß-quartz can be predominant.

In further embodiments, the median grain size can be in a range from about 600 nanometers to about 800 nanometers.

In further embodiments, the lithium disilicate crystals can be substantially interlocked.

In further embodiments, the optical diffuser can comprise a light transmittance ranging from about 40% to about 70%.

In further embodiments, the optical diffuser can comprise a haze of about 95% or more.

In further embodiments, the optical diffuser can comprise an integrated light transmission of about 40% or more.

In further embodiments, the optical diffuser can comprise a hiding power of about 20 millimeters or less.

In further embodiments, the optical diffuser can comprise a color shift of about 0.2 or less.

### BRIEF DESCRIPTION OF THE DRAWINGS

The above and other features and advantages of embodiments of the present disclosure are better understood when the following detailed description is read with reference to the accompanying drawings, in which:

FIG. 1 shows exemplary embodiments of an optical diffuser and a display device in accordance with the embodiments of the disclosure;

FIG. 2 is an enlarged view 2 of FIG. 1 showing a schematic representation of a scanning electron microscope (SEM) image of some embodiments of the disclosure;

FIG. 3 is an enlarged view 2 of FIG. 1 showing a schematic representation of a scanning electron microscope (SEM) image of some embodiments of the disclosure;

FIG. 4 is a schematic representation of an X-ray diffraction (XRD) image of some embodiments of the disclosure;

FIG. 5 is a schematic representation of a cumulative crystal grain sizes of some embodiments of the disclosure;

FIG. 6 is a hiding power test apparatus in accordance with some embodiments of the disclosure; and

FIG. 7 is a flow chart illustrating example methods of the embodiments of the disclosure.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, claims may encompass many different aspects of various embodiments and should not be construed as limited to the embodiments set forth herein.

Unless otherwise noted, a discussion of features of some embodiments can apply equally to corresponding features of any of the embodiments of the disclosure. For example, identical part numbers throughout the disclosure can indicate that, in some embodiments, the identified features are identical to one another and that the discussion of the identified feature of one embodiment, unless otherwise noted, can apply equally to the identified feature of any of the other embodiments of the disclosure.

As used herein, “glass-ceramics” comprise one or more crystalline phases and an amorphous, residual glass phase. Amorphous materials and glass-ceramics may be strengthened. As used herein, the term “strengthened” may refer to a material that has been chemically strengthened, for example, through ion-exchange of larger ions for smaller ions in the surface of the substrate, as discussed below. However, other strengthening methods known in the art, for example, thermal tempering, or utilizing a mismatch of the coefficient of thermal expansion between portions of the substrate to create compressive stress and central tension regions, may be utilized to form strengthened substrates.

“Glass-ceramics” include materials produced through controlled crystallization of glass. In some embodiments, glass-ceramics have from about 1% to about 99% crystallinity. Embodiments of suitable glass-ceramics of the embodiments of the disclosure may include Li₂O—Al₂O₃—SiO₂ system (i.e., LAS-System) glass-ceramics and/or glass-ceramics that include a crystal phase including β-quartz solid solution, β-spodumene, cordierite, petalite, and/or lithium disilicate. In some embodiments, a glass-ceramic material can be formed by heating a glass-based material to form ceramic (e.g., crystalline) portions. In further embodiments, glass-ceramic materials may comprise one or more nucleating agents that can facilitate the formation of crystalline phase(s).

As used herein, “an oxide basis” means the component is measured as if the non-oxygen components in the compound were converted into a specified oxide form or a fully oxidized oxide if a specific oxide form is not specified. For example, sodium (Na) on an oxide basis refers to amounts in terms of sodium oxide (Na₂O) while silicon, silica, silicate on an oxide basis refers to amounts in terms of silicon dioxide (SiO₂). As such, a component need not actually be in the specified oxide form or in the fully oxidized oxide form in order for the component to count in measures on “an oxide basis.” As used herein, mole percent (mol %) refers to a proportion of the total number of moles in a mixture, composition, or glass-ceramic article that comprise the specific component. As such, a measurement “an oxide basis in mole percent (mol %)” for a specific component comprises conceptually converting materials comprising the non-oxygen element of the specific component into the specified oxide form or the fully oxidized oxide if a specific oxide form is not specified before calculating the percentage of the total number of moles on an oxide basis in the mixture, composition, or glass-ceramic article. As used herein, amounts of components on an oxide basis in mol % are equally applicable to mixtures, compositions, and glass-ceramic articles that can be used, for example, as an optical diffuser. Accordingly, when an optical diffuser is described herein as comprising an amorphous phase and/or a crystalline phase and recites a mol % (or mol % range) of an oxide (e.g., on an “oxide basis”), such mol % (or mol % range) refers to the total relative molar contribution of that oxide (e.g., as an initial formulation component or an initial formulation component that could be converted into the specified oxide) to all of the amorphous and/or crystalline species in the optical diffuser.

The glass-ceramics of the embodiments of the disclosure comprise alkali-containing aluminosilicate and/or alkali-containing aluminoborosilicate compositions. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In some embodiments, a glass-based substrate may optionally further comprise a range from 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. In some embodiments, the glass-ceramic materials can comprise one or more oxide, nitride, oxynitride, carbide, boride, silicate, and/or silicide. Example embodiments of oxides include silica (SiO₂), zirconia (ZrO₂), zircon (ZrSiO₄), alumina (Al₂O₃) an alkali metal oxide (e.g., potassium oxide (K₂O), sodium oxide (Na₂O), lithium oxide (Li₂O)), an alkali earth metal oxide (e.g., magnesium oxide (MgO), calcium oxide (CaO), strontium oxide (SrO)), titania (TiO₂), zinc oxide (ZnO), tin oxide (SnO₂), phosphorous pentoxide (P₂O₅), boron trioxide (B₂O₃), hafnium oxide (Hf₂O), yttrium oxide (Y₂O₃), iron oxide, beryllium oxide, vanadium oxide (VO₂), fused quartz, mullite (a mineral comprising a combination of aluminum oxide and silicon dioxide), and spinel (MgAl₂O₄). Example embodiments of nitrides include silicon nitride (Si₃N₄), aluminum nitride (AlN), gallium nitride (GaN), beryllium nitride (Be₃N₂), boron nitride (BN), tungsten nitride (WN), vanadium nitride, alkali earth metal nitrides (e.g., magnesium nitride (Mg₃N₂)), nickel nitride, and tantalum nitride. Example embodiments of oxynitrides include silicon oxynitride, aluminum oxynitride, and a SiAlON (a combination of alumina and silicon nitride and can have a chemical formula, for example, Si₁₂₋ₘ₋ₙAlₘ₊ₙOₙN₁₆₋ₙ, Si₆₋ₙAlₙOₙN₈₋ₙ, or Si₂₋ₙAlₙO₁₊ₙN₂₋ₙ, where m, n, and the resulting subscripts are all non-negative integers). Example embodiments of carbides and carbon-containing ceramics include silicon carbide (SiC), tungsten carbide (WC), an iron carbide, boron carbide (B₄C), alkali metal carbides (e.g., lithium carbide (Li₄C₃)), alkali earth metal carbides (e.g., magnesium carbide (Mg₂C₃)), and graphite. Example embodiments of borides include chromium boride (CrB₂), molybdenum boride (Mo₂B₅), tungsten boride (W₂B₅), iron boride, titanium boride, zirconium boride (ZrB₂), hafnium boride (HfB₂), vanadium boride (VB₂), Niobium boride (NbB₂), and lanthanum boride (LaB₆). Example embodiments of silicides include molybdenum disilicide (MoSi₂), tungsten disilicide (WSi₂), titanium disilicide (TiSi₂), nickel silicide (NiSi), alkali earth silicide (e.g., sodium silicide (NaSi)), alkali metal silicide (e.g., magnesium silicide (Mg₂Si)), hafnium disilicide (HfSi₂), and platinum silicide (PtSi).

Embodiments of the disclosure can comprise, on an oxide basis, silica (SiO₂). Silica can comprise the highest mol % on an oxide basis in the mixture, composition, and/or glass-ceramic article. Silica can be part of both a glass phase and one or more crystalline phases. Without wishing to be bound by theory, silica may be a component of lithium disilicate, ß-spodumene, and ß-quartz crystals. Accordingly, when an optical diffuser is described herein as comprising an amorphous phase and/or a crystalline phase and recites a mol % (or mol % range) of silica or a silicon-containing component that could be converted into silica (e.g., on an “oxide basis”), such mol % (or mol % range) refers to the total relative molar contribution of silica (e.g., as an initial formulation component) to all of the amorphous and/or crystalline species in the optical diffuser. Consequently, the silica content should be sufficiently high (e.g., about 60% or more on an oxide basis in mol %) to enable crystal formation and stabilization of the glass phase. Additionally, without wishing to be bound by theory, increasing silica content can decrease a liquidus viscosity of the resulting mixture, composition, and/or glass-ceramic article. Consequently, the silica content can be limited (e.g., about 75% or less) to facilitate processing with a suitable liquidus viscosity (e.g., about 80 Pascal-seconds or more). In some embodiments, an amount of silica on an oxide basis in mol % can be about 60% or more, about 65% or more, about 67% or more, about 68% or more, about 70% or more, about 72% or more, about 75% or less, about 72% or less, about 71% or less, about 70% or less, or about 68% or less. In some embodiments, an amount of silica on an oxide basis in mol % can range from about 60% to about 75%, from about 65% to about 72%, from about 65% to about 71%, from about 65% to about 70%, from about 67% to about 70%, from about 68% to about 70%, from about 60% to about 72%, from about 65% to about 71%, from about 67% to about 71%, from 68% to about 71%, from about 65% to about 75%, from about 68% to about 72%, from about 70% to about 72%, from about 710% to about 72%, or any range or subrange therebetween.

Embodiments of the disclosure can comprise, on an oxide basis, alumina (Al₂O₃). Without wishing to be bound by theory, alumina may be a component of ß-spodumene crystals. Accordingly, when an optical diffuser is described herein as comprising an amorphous phase and/or a crystalline phase and recites a mol % (or mol % range) of alumina or an aluminum-containing component that could be converted into alumina (e.g., on an “oxide basis”), such mol % (or mol % range) refers to the total relative molar contribution of alumina (e.g., as an initial formulation component) to all of the amorphous and/or crystalline species in the optical diffuser. However, the alumina content can be limited (e.g., about 7% or less on an oxide basis in mol %) to enable ß-spodumene crystals with the grain size discussed below without growing too large and enable lithium disilicate crystals to be substantially interlocked. Additionally, increasing alumina content can increase a liquidus viscosity of the mixture, composition, and/or glass-ceramic article. Limiting the alumina content can enable processing by maintaining a liquidus viscosity of about 1,000 Pascal-seconds or less. Additionally, increasing alumina content can increase the mechanical properties of the resulting glass-ceramic article. In some embodiments, an amount of alumina on an oxide basis in mol % can be about 2% or more, about 2.5% or more, 3% or more, about 3.5% or more, about 4% or more, about 5% or more, about 9% or less, about 7% or less, about 6% or less, about 5% or less, about 4.5% or less, about 4% or less, about 3.5% or less, or about 3% or less. In some embodiments, an amount of alumina on an oxide basis in mol % can range from about 2% to about 9%, from about 2% to about 7%, from about 2% to about 6%, from about 2% to about 5%, from about 2% to about 4.5%, from about 2.5% to about 4.5%, from 2.5% to about 4%, from about 2.5% to about 3.5%, from about 2.5% to about 3%, from about 2.5% to about 9%, from about 2.5% to about 7%, from about 2.5% to about 6%, from about 2.5% to about 5%, from about 3% to about 5%, from about 3% to about 4.5%, from about 3% to about 4%, from about 3% to about 9%, from about 3% to about 7%, from about 3.5% to about 7%, from about 3.5% to about 6%, from about 3.5% to about 5%, from about 3.5% to about 4.5%, or any range or subrange therebetween.

Embodiments of the disclosure can comprise, on an oxide basis, lithium oxide (Li₂O). Without wishing to be bound by theory, lithium oxide may be a component of ß-spodumene crystals. Accordingly, when an optical diffuser is described herein as comprising an amorphous phase and/or a crystalline phase and recites a mol % (or mol % range) of lithium oxide or a lithium-containing component that could be converted into lithium oxide (e.g., on an “oxide basis”), such mol % (or mol % range) refers to the total relative molar contribution of lithium (e.g., as an initial formulation component) to all of the amorphous and/or crystalline species in the optical diffuser. Providing sufficient lithium oxide content (e.g., about 17% or more on an oxide basis in mol %) can enable ß-spodumene to be the predominant crystal phase in the resulting glass-ceramic article. Increasing lithium oxide content can decrease the liquidus viscosity of the mixture, composition, and/or glass-ceramic article. However, the lithium oxide content can be limited (e.g., about 25% or less on an oxide basis in mol %) to facilitate processing of the composition (e.g., a liquidus viscosity of about 80 Pascal-seconds or more) and enable ß-spodumene crystals with the grain size discussed below without growing too large. In some embodiments, an amount of lithium oxide on an oxide basis in mol % can be about 17% or more, about 19% or more, about 20% or more, about 21% or more, about 22% or more, about 25% or less, about 24% or less, about 23% or less, or about 22% or less. In some embodiments, an amount of lithium oxide on an oxide basis in mol % can range from about 17% to about 25%, from about 17% to about 24%, from about 17% to about 23%, from about 19% to about 23%, from about 20% to about 23%, from about 21% to about 23%, from about 22% to about 23%, from about 19% to about 25%, from about 21% to about 25%, from about 21% to about 24%, from about 22% to about 24%, or any range or subrange therebetween.

Embodiments of the disclosure can comprise, on an oxide basis, alkali metal oxides in addition to Li₂O. Generally, increasing alkali metal oxide content can decrease the liquidus temperature of the mixture, composition, and/or glass-ceramic. In some embodiments, a total amount of alkali metal oxides, excluding Li₂O, on an oxide basis in mol % can be about 0.5% or more, about 1% or more, about 1.5% or more, about 2% or more, about 6% or less, about 4% or less, about 3% or less, about 2.5% or less, or about 2% or less. In some embodiments, a total amount of alkali metal oxides, excluding Li₂O, on an oxide basis in mol % can range from about 0.5% to about 6%, from about 0.5% to about 4%, from about 0.5% to about 3%, from about 0.5% to about 2.5%, from about 1% to about 6%, from about 1% to about 4%, from about 1% to about 3%, from about 1.5% to about 3%, from about 1.5% to about 2.5%, from about 1.5% to about 2%, from about 2% to about 3%, or any range or subrange therebetween.

In some embodiments, the embodiments of the disclosure can comprise alkali metal oxides comprising sodium oxide (Na₂O) and/or potassium oxide (K₂O). Accordingly, when an optical diffuser is described herein as comprising an amorphous phase and/or a crystalline phase and recites a mol % (or mol % range) of sodium oxide or a sodium-containing component that could be converted into sodium oxide (e.g., on an “oxide basis”), such mol % (or mol % range) refers to the total relative molar contribution of sodium oxide (e.g., as an initial formulation component) to all of the amorphous and/or crystalline species in the optical diffuser. Increasing sodium oxide and/or potassium oxide content can decrease the liquidus viscosity of the mixture, composition, and/or glass-ceramic article, which can reduce damage to the composition during a thermal treatment process involving nucleation and/or crystallization. Additionally, sodium oxide content can facilitate subsequent ion-exchange (e.g., chemical strengthening) of the resulting glass-ceramic article. In further embodiments, an amount of sodium oxide on an oxide basis in mol % can be about 0.5% or more, about 1% or more, about 1.5% or more, about 6% or less, about 4% or less, about 2% or less, or about 1.5% or less. In further embodiments, an amount of sodium oxide on an oxide basis in mol % can range from about 0.5% to about 6%, from about 0.5% to about 4%, from about 0.5% to about 2%, from about 0.5% to about 1.5%, from about 1% to about 1.5%, from about 1% to about 6%, from about 1% to about 4%, from about 1% to about 2%, from about 1.5% to about 2%, or any range or subrange therebetween. In further embodiments, an amount of potassium oxide on an oxide basis in mol % can be 0% or more, about 0.5% or more, about 5.5% or less, about 4% or less, about 2% or less, or about 1% or less. In further embodiments, an amount of potassium oxide on an oxide basis in mol % can range from 0% to about 5.5%, from 0% to about 4%, from 0% to about 2%, from 0% to about 1%, from about 0.5% to about 5.5%, from about 0.5% to about 4%, from about 0.5% to about 2%, from about 0.5% to about 1%, or any range or subrange therebetween.

Embodiments of the disclosure can comprise, on an oxide basis, phosphorous pentoxide (P₂O₅). Phosphorous pentoxide can act as a nucleation agent, facilitating crystal formation. Providing a minimum amount of phosphorous pentoxide (e.g., about 0.5% on an oxide basis in mol %) can facilitate crystal formation. Accordingly, when an optical diffuser is described herein as comprising an amorphous phase and/or a crystalline phase and recites a mol % (or mol % range) of phosphorous pentoxide or a phosphorous-containing component that could be converted into phosphorous pentoxide (e.g., on an “oxide basis”), such mol % (or mol % range) refers to the total relative molar contribution of phosphorous pentoxide (e.g., as an initial formulation component) to all of the amorphous and/or crystalline species in the optical diffuser. Consequently, increasing phosphorous pentoxide content can increase a density of crystals in the glass-ceramic article. Limiting the phosphorous pentoxide content (e.g., about 5% or less on an oxide basis in mol %) can enable control of the crystal density to obtain the transparency and haze values discussed below. In some embodiments, an amount of phosphorous pentoxide on an oxide basis in mol % can be about 0.5% or more, about 1% or more, about 2% or less, or about 1.5% or less. In some embodiments, an amount of phosphorous pentoxide on an oxide basis in mol % can range from about 0.5% to about 2%, from about 0.5% to about 1.5%, from about 1% to about 2%, from about 1% to about 1.5%, or any range or subrange therebetween.

Embodiments of the disclosure can comprise, on an oxide basis, zirconia (ZrO₂). Increasing zirconia content can facilitate processing of the composition and/glass-ceramic article without devitrification (e.g., by decreasing a liquidus temperature). Limiting zirconia content can prevent formation of other crystal phases. Accordingly, when an optical diffuser is described herein as comprising an amorphous phase and/or a crystalline phase and recites a mol % (or mol % range) of zirconia or a zirconium-containing component that could be converted into zirconia (e.g., on an “oxide basis”) (e.g., on an “oxide basis”), such mol % (or mol % range) refers to the total relative molar contribution of zirconia (e.g., as an initial formulation component) to all of the amorphous and/or crystalline species in the optical diffuser. In some embodiments, an amount of zirconia on an oxide basis in mol % can be about 1% or more, about 1.5% or more, about 2% or more, about 2.5% or more, about 3% or more, about 3.5% or more, about 5% or less, about 4% or less, about 3.5%, or 3% or less. In some embodiments, an amount of zirconia on an oxide basis in mol % can range from about 1% to about 5%, from about 1.5% to about 4%, from about 1.5% to about 3.5%, from about 1.5% to about 3%, from about 1.5% to about 5%, from about 2% to about 5%, from about 2% to about 4%, from about 2.5% to about 4%, from about 3% to about 4%, from about 3.5% to about 4%, or any range or subrange therebetween.

Embodiments of the disclosure can comprise, on an oxide basis, boron trioxide (B₂O₃). Increasing boron trioxide content can enable the resulting glass-ceramic article to withstand flexure and deformation without failure and/or resist crack propagation. Additionally, increasing boron trioxide content can decrease the liquidus temperature of the mixture, composition, and/or glass-ceramic article. Accordingly, when an optical diffuser is described herein as comprising an amorphous phase and/or a crystalline phase and recites a mol % (or mol % range) of boron trioxide or a boron-containing component that could be converted into boron trioxide (e.g., on an “oxide basis”) (e.g., on an “oxide basis”), such mol % (or mol % range) refers to the total relative molar contribution of boron trioxide (e.g., as an initial formulation component) to all of the amorphous and/or crystalline species in the optical diffuser. In some embodiments, an amount of boron trioxide on an oxide basis in mol % can be 0% or more, about 0.5% or more, about 1% or more, about 5% or less, about 3% or less, about 2% or less, or about 1% or less. In some embodiments, an amount of boron trioxide on an oxide basis in mol % can range from 0% to about 5%, from 0% to about 3%, from 0% to about 2%, from 0% to about 1%, from about 0.5% to about 5%, from about 0.5% to about 3%, from about 0.5% to about 2%, from about 0.5% to about 1%, or any range or subrange therebetween.

Embodiments of the disclosure can comprise, on an oxide basis, alkali earth metal oxides. Alkali earth metal oxides can help stabilize the crystal phase and/or solid solution. In some embodiments, a total amount of alkali earth metal oxides on an oxide basis in mol % can be 0% or more, about 0.5% or more, about 1% or more, about 5% or less, about 3% or less, or about 2% or less. In some embodiments, a total amount of alkali earth metal oxides on an oxide basis in mol % can range from 0% to about 5%, from 0% to about 3%, from 0% to 2%, from about 0.5% to about 5%, from about 0.5% to about 3% from about 0.5% to about 2%, from about 1% to about 5%, from about 1% to about 3%, from about 1% to about 5%, or any range or subrange therebetween.

Embodiments of the disclosure can comprise, on an oxide basis, zinc oxide (ZnO). Zinc oxide can help stabilize the crystal phase and/or solid solution. Accordingly, when an optical diffuser is described herein as comprising an amorphous phase and/or a crystalline phase and recites a mol % (or mol % range) of zinc oxide or a zinc-containing component that could be converted into zinc oxide (e.g., on an “oxide basis”) (e.g., on an “oxide basis”), such mol % (or mol % range) refers to the total relative molar contribution of zinc oxide (e.g., as an initial formulation component) to all of the amorphous and/or crystalline species in the optical diffuser. In some embodiments, an amount of zinc oxide on an oxide basis in mol % can be 0% or more, about 0.5% or more, about 1% or more, about 2% or less, about 1.5% or less, or about 1% or less. In some embodiments, an amount of zinc oxide on an oxide basis in mol % can range from 0% to about 2%, from 0% to about 1.5%, from 0% to about 1%, from 0.5% to about 1%, from about 0.5% to about 2%, from about 0.5% to about 1%, or any range or subrange therebetween.

Embodiments of the disclosure can comprise, on an oxide basis, tin oxide (SnO₂). Without wishing to be bound by theory, tin oxide can opacify the resulting glass-ceramic oxide. Providing a small amount of tin oxide (e.g., about 1% on an oxide basis in mol %) can increase the haze of the glass-ceramic article without significantly impacting light transmittance. Accordingly, when an optical diffuser is described herein as comprising an amorphous phase and/or a crystalline phase and recites a mol % (or mol % range) of tin oxide or a tin-containing component that could be converted into tin oxide (e.g., on an “oxide basis”) (e.g., on an “oxide basis”), such mol % (or mol % range) refers to the total relative molar contribution of tin oxide (e.g., as an initial formulation component) to all of the amorphous and/or crystalline species in the optical diffuser. In some embodiments, an amount of tin oxide on an oxide basis in mol % can be about 0% or more, about 0.1% or more, about 0.5% or more, about 2% or more, about 1% or less, about 0.5% or less, or about 0.2% or less. In some embodiments, an amount of tin oxide on an oxide basis in mol % can range from 0% to about 2%, from 0% to about 1%, from 0% to about 0.5%, from 0% to about 0.2%, from 0% to about 0.1%, from about 0.1% to about 5%, from about 0.1% to about 2%, from about 0.1% to about 1%, from about 0.1% to about 0.5%, or any range or subrange therebetween.

As used herein, a composition that is “substantially free of” a component means that the component is not intentionally added to the composition and/or the composition contains only trace amounts of the composition, for example, about 0.01 mol % on an oxide basis. In some embodiments, a mixture, composition, or glass-ceramic article can be substantially free of a photosensitizer. Without wishing to be bound by theory, a photosensitizer increases the absorption of one or more wavelengths of visible light, which can decrease transparency and/or impart color to the mixture, composition, or glass-ceramic article. In some embodiments, the mixture, composition, or glass-ceramic article can be substantially free of a photosensitizer comprising one or more of the following on an oxide basis: titanium (TiO₂), iron (Fe₂O₃), lead (PbO), arsenic (As₂O₃), bismuth (Bi₂O₃), molybdenum (MoO₃), tantalum (Ta₂O₅), niobium (Nb₂O₅), yttrium (Y₂O₃), cadmium (CdO), hand/or cerium (CeO₂). In some embodiments, a mixture, composition, or glass-ceramic article can be substantially free of noble metals. Without wishing to be bound by theory, noble metals can increase reflectance, which can decrease the light transmittance and/or produce undesirable brightness variation (e.g., bright spots, dark spots). In some embodiments, a mixture, composition, or glass-ceramic article can be substantially free of a noble metal comprising one or more of the following on an oxide basis: silver (Ag₂O), gold (Au₂O₃), platinum (PtO₂), palladium (PdO), and/or rhenium (Rh₂O₃). In some embodiments, the mixture, composition, and/or glass-ceramic article can be substantially free of fluorine (F) and/or fluorine-containing components. Without wishing to be bound by theory, fluorine and/or fluorine-containing components can facilitate the formation of crystal phases (e.g., F-canasite, F-apatite) other than lithium disilicate, ß-spodumene, and ß-quartz that can degrade the optical properties of the resulting glass-ceramic article and/or compete with the other crystal phases.

It is to be understood that any of the above ranges for the above-mentioned components can be combined in some embodiments of the disclosure. Example ranges of some embodiments of the disclosure are presented in Table 1. R1 is the broadest of the ranges in Table 1 while R2 and R9 are the narrowest ranges of the ranges in Table 1. R3-R8 and R10 represent intermediate ranges. Again, it is to be understood that other ranges or subranges discussed above for these components can be used in combination with any of the ranges presented in Table 1.

TABLE 1
Composition ranges (mol %) on an oxide basis of some embodiments

| Range | SiO₂ | Al₂O₃ | LiO₂ | Na₂O | K₂O | B₂O₃ | P₂O₅ | ZrO₂ | SnO₂ |
|---|---|---|---|---|---|---|---|---|---|
| R1 | 60-75 | 2-9 | 17-25 | 0.5-6 | 0-5.5 | 0-5 | 0.5-2 | 1.5-4 | 0-2 |
| R2 | 67-70 | 2.5-4.5 | 21-24 | 0.5-2 | 0-1 | 0-1 | 0.5-2 | 1.5-4 | 0-2 |
| R3 | 67-70 | 2-9 | 17-25 | 0.5-6 | 0-5.5 | 0-5 | 0.5-2 | 1.5-4 | 0-2 |
| R4 | 60-75 | 2.5-4.5 | 17-25 | 0.5-6 | 0-5.5 | 0-5 | 0.5-2 | 1.5-4 | 0-2 |
| R5 | 60-75 | 2-9 | 21-24 | 0.5-6 | 0-5.5 | 0-5 | 0.5-2 | 1.5-4 | 0-2 |
| R6 | 60-75 | 2-9 | 17-25 | 0.5-2 | 0-5.5 | 0-5 | 0.5-2 | 1.5-4 | 0-2 |
| R7 | 67-70 | 2.5-4.5 | 17-25 | 0.5-6 | 0-5.5 | 0-5 | 0.5-2 | 1.5-4 | 0-2 |
| R8 | 67-70 | 2.5-4.5 | 21-24 | 0.5-6 | 0-5.5 | 0-5 | 0.5-2 | 1.5-4 | 0-2 |
| R9 | 67-70 | 2.5-4.5 | 21-24 | 0.5-6 | 0-5.5 | 0-5 | 0.5-2 | 1.5-4 | 0.1 |
| R10 | 67-70 | 2.5-4.5 | 21-24 | 0.5-2 | 0-5.5 | 0-1 | 0.5-2 | 1.5-4 | 0-2 |

The mixture, composition, and/or glass-ceramic article can comprise a liquidus temperature and/or liquidus viscosity. As used herein, “liquidus temperature” means the lowest temperature above which no crystal can exist within the material (e.g., the material is completely liquid). In other words, the liquidus temperature is the maximum temperature at which crystals can coexist with a liquid (e.g., melt, molten) phase of the material at thermodynamic equilibrium. In some embodiments, the liquidus temperature can be about 1000° C. or more, about 1030° C. or more, about 1050° C. or more, about 1075° C. or more, about 1250° C. or less, 1220° C. or less, about 1100° C. or less, or about 1085° C. or less. In some embodiments, the liquidus temperature can range from about 1000° C. to about 1250° C., from about 1000° C. to about 1220° C., from about 1000° C. to about 1100° C., from about 1000° C. to about 1085° C., from about 1030° C. to about 1085° C., from about 1050° C. to about 1080° C., from about 1030° C. to about 1250° C., from about 1030° C. to about 1220° C., from about 1050° C. to about 1220° C., from about 1075° C. to about 1220° C., from about 1075° C. to about 1100° C., or any range or subrange therebetween.

As used herein, “liquidus viscosity” means a viscosity of the material when the material at the liquidus temperature. Viscosity at the liquidus temperature is measured using ASTM C965-96(2017). In some embodiments, the liquidus viscosity can be about 80 Pascal-seconds (Pa-s) or more, about 100 Pa-s or more, about 140 Pa-s or more, about 200 Pa-s or more, about 300 Pa-s or more, about 1,000 Pa-s or less, about 600 Pa-s or less, about 500 Pa-s or less, or about 300 Pa-s or less. In some embodiments, the liquidus viscosity can range from about 80 Pascal-seconds (Pa-s) to about 1,000 Pa-s, from about 80 Pa-s, from about 80 Pa-s to about 600 Pa-s, from about 100 Pa-s to about 600 Pa-s, from about 140 Pa-s to about 600 Pa-s, from about 140 Pa-s to about 500 Pa-s, from about 140 Pa-s to about 300 Pa-s, from about 200 Pa-s to about 300 Pa-s, from about 140 Pa-s to about 1,000 Pa-s, from about 200 Pa-s to about 1,000 Pa-s, from about 200 Pa-s to about 600 Pa-s, from about 200 Pa-s to about 500 Pa-s, from about 300 Pa-s to about 500 Pa-s, or any range or subrange therebetween.

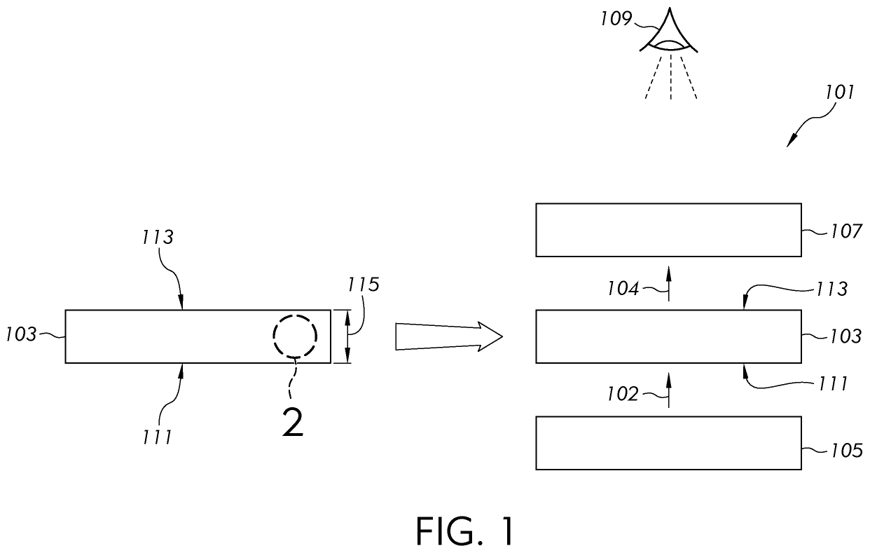

FIG. 1 shows an example embodiment of an optical diffuser 103 comprising a glass-ceramic article. The optical diffuser can comprise a first major surface 111 and a second major surface 113 opposite the first major surface 111. In some embodiments, as shown, the first major surface 111 can comprise a planar surface. In some embodiments, as shown, the second major surface 113 can comprise a planar surface. In some embodiments, as shown, the first major surface 111 can be substantially parallel to the second major surface 113. In some embodiments, the optical diffuser can comprise one or more edges extending between the first major surface 111 and the second major surface 113. A thickness 115 of the optical diffuser can be defined as a distance between the first major surface 111 and a second major surface 113 averaged across the first major surface 111. In some embodiments, the thickness 115 of the optical diffuser 103 can be about 0.1 millimeters (mm) or more, about 0.5 mm or more, about 0.8 mm or more, about 1 mm or more, about 10 mm or less, about 8 mm or less, about 5 mm or less, about 3 mm or less, or about 2 mm or less. In some embodiments, the thickness 115 of the optical diffuser 103 can range from about 0.1 mm to about 10 mm, from about 0.1 mm to about 8 mm, from about 0.5 mm to about 8 mm, from about 0.5 mm to about 5 mm, from about 0.5 to about 3 mm, from about 0.5 to about 2 mm, from about 1 mm to about 2 mm, from about 0.5 mm to about 10 mm, from about 1 mm to about 10 mm, from about 1 mm to about 8 mm, from about 1 mm to about 5 mm, from about 1 mm to about 3 mm, or any range or subrange therebetween.

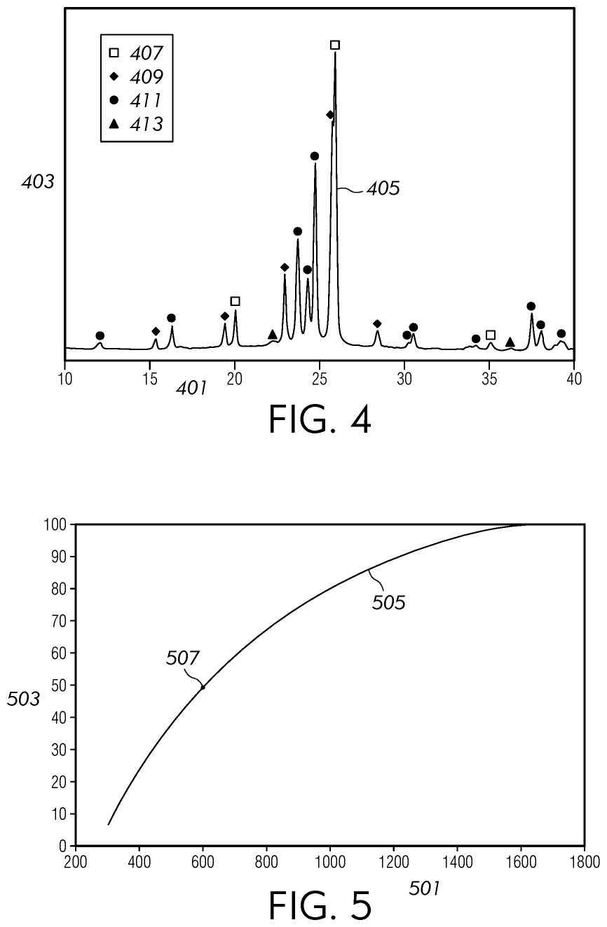

The glass-ceramic article can comprise one or more crystal phases. Crystal phases and crystal sizes can be determined using X-ray diffraction (XRD). For example, as shown in FIG. 4, a distinctive series of peaks 405 associated with a given crystal phase when plotting a double angle 401 of the scattering angle against the detected intensity 403. As shown, the peaks 405 can be associated with ß-quartz 407 (open squares), ß-spodumene 409 (diamonds), lithium disilicate 411 (circles), and even trace quantities of lithiophosphate 413 (triangles).

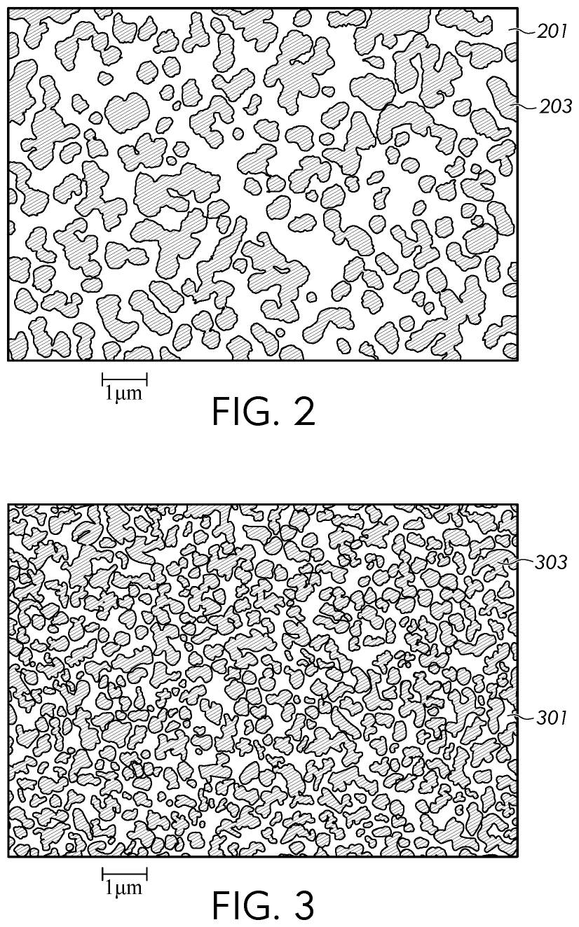

A grain size distribution of the one or more crystal phases and/or crystals can be determined using image analysis of scanning electron microscope (SEM) images. For example, FIGS. 2-3 show a schematic representation of SEM images of some embodiments of the disclosure. In some embodiments, the sample area of the SEM image can range from about 25 μm² to about 100 μm², for example, from about 49 μm² to about 81 μm². In some embodiments, a measured grain size of a crystal for determining the grain size distribution represents an average dimension of a crystal. In further embodiments, the measured grain size for ß-quartz and/or ß-spodumene can comprise an approximate radius of crystals comprising a substantially circular cross-section in the SEM image. For example, FIG. 5 shows a cumulative distribution 505 of grain sizes for crystals comprising a substantially circular cross-section with a median 507 (50 percentile) grain size of about 600 nanometers (nm). In FIG. 5, the horizontal axis (e.g., x-axis) 501 comprises the measured grain size and the vertical axis (e.g., y-axis) 503 comprises the cumulative percent of crystals. In some embodiments, a median grain size can be about 500 nm or more, about 550 nm or more, about 600 nm or more, about 650 nm or more, about 700 nm or more, about 1,000 nm or less, about 900 nm or less, about 800 nm or less, about 750 nm or less, or about 700 nm or less. In some embodiments, a median grain size can range from about 500 nm to about 1,000 nm, from about 500 nm to about 900 nm, from about 500 nm to about 800 nm, from about 550 to about 800 nm, from about 600 nm to about 800 nm, from about 650 nm to about 800 nm, from about 700 nm to about 800 nm, from about 500 nm to about 800 nm, from about 500 nm to about 700 nm, from about 550 nm to about 700 nm, from about 600 nm to about 700 nm, or any range or subrange therebetween. Providing crystals with a median grain size ranging from about 500 nanometers to about 1,000 nanometers (e.g., from 600 nanometers to about 800 nanometers) can increase scattering of visible light (e.g., from about 380 nanometers to about 740 nanometers, from about 400 nanometers to about 700 nanometers), which can increase the haze and hiding power of the glass-ceramic article for visible light.

In some embodiments, the one or more crystal phases and/or crystals can be dispersed throughout a volume of the glass-ceramic article (e.g., optical diffuser). As used herein, crystal phases and/or crystals are “dispersed throughout a volume” of the glass-ceramic article if one or more crystal phases or crystals do not intersect a major surface nor an edge of the glass-ceramic article (e.g., optical diffuser). In further embodiments, one or more crystal phases can be dispersed substantially uniformly throughout the volume of the optical diffuser.

In some embodiments, the glass-ceramic article can comprise lithium disilicate crystals. In further embodiments, the lithium disilicate crystals can be dispersed throughout a volume of the glass-ceramic article (e.g., optical diffuser). In further embodiments, the lithium disilicate crystals can be substantially interlocked. As used herein, “interlocked” crystals means that a crystal of a crystal type is within a median grain size of another crystal of the same crystal type. Providing lithium disilicate crystals can increase the mechanical stability and mechanical strength of the glass-ceramic article. Providing substantially interlocking lithium disilicate crystals can further increase the mechanical stability and mechanical strength of the glass-ceramic article. Without wishing to be bound by theory, substantially interlocked lithium disilicate crystals can increase mechanical stability and mechanical strength, for example, because the substantially interlocked lithium disilicate crystals force cracks propagating through the glass-ceramic article (e.g., optical diffuser) to take a tortuous path around the crystals.

In some embodiments, the glass-ceramic article can comprise ß-spodumene crystals. In further embodiments, ß-spodumene can comprise the predominant crystal phase in the glass-ceramic article (e.g., optical diffuser). As used herein, a crystal type is predominant in the crystal phase if a total volume of all crystals of the crystal type comprises more volume than any of the other crystal types (e.g., plurality, majority). In further embodiments, the ß-spodumene crystals can be dispersed throughout a volume of the glass-ceramic article (e.g., optical diffuser). In further embodiments, the glass-ceramic article can comprise both lithium disilicate and ß-spodumene crystals. Without wishing to be bound by theory, ß-spodumene crystals can increase light scattering of the glass-ceramic article, which can increase the haze and hiding power of the glass-ceramic article. In some embodiments, the median crystal grain size distribution can be measured for ß-spodumene crystals. In further embodiments, the median crystal grain size distribution can be measured for ß-spodumene crystals comprising substantially circular cross-sections. In further embodiments, the median crystal grain size distribution measured for ß-spodumene crystals can be within one or more of the ranges mentioned above (e.g., from about 500 nm to about 1,000 nm, from about 600 nm to about 800 nm).

In some embodiments, the glass-ceramic article can comprise ß-quartz crystals. In further embodiments, ß-quartz can comprise the predominant crystal phase in the glass-ceramic article (e.g., optical diffuser). In further embodiments, the ß-quartz crystals can be dispersed throughout a volume of the glass-ceramic article (e.g., optical diffuser). In further embodiments, the glass-ceramic article can comprise both lithium silicate and ß-quartz crystals. In even further embodiments, the glass-ceramic article can comprise lithium disilicate, ß-spodumene, and ß-quartz crystals. Without wishing to be bound by theory, ß-quartz crystals can increase light scattering of the glass-ceramic article, which can increase the haze and hiding power of the glass-ceramic article. In some embodiments, the median crystal grain size distribution can be measured for ß-quartz crystals. In further embodiments, the median crystal grain size distribution can be measured for ß-quartz crystals comprising substantially circular cross-sections. In further embodiments, the median crystal grain size distribution measured for ß-quartz crystals can be within one or more of the ranges mentioned above (e.g., from about 500 nm to about 1,000 nm, from about 600 nm to about 800 nm).

In some embodiments, the glass-ceramic article (e.g., optical diffuser) can comprise a light transmittance. As sued herein, light transmittance is measured in the optical wavelength range from 400 nm to 700 nm by averaging measurements of light transmittance for whole number wavelengths from about 400 nm to about 700 nm through a glass-ceramic article comprising a thickness of 1.2 mm. Light transmittance was measured using a Perkin Elmer 950 UV-Vis-NIR Spectrophotometer with measurements taken every 2 nm in optical wavelength using tungsten-halogen and InGaAs light sources. In some embodiments, the light transmittance can be about 40% or more, about 45% or more, about 50% or more, about 70% or less, about 60% or less, or about 55% or less. In some embodiments, the light transmittance can range from about 40% to about 70%, from about 40% to about 60%, from about 40% to about 55%, from about 45% to about 55%, from about 50% to about 55%, from about 45% to about 70%, from about 45% to about 60%, from about 50% to about 60%, or any range or subrange therebetween. Providing a glass-ceramic article comprising high light transmittance (e.g., about 40% or more, about 50% or more) can increase efficiently transmitting light, which can increase illumination from a display device and decrease an amount of energy from an illumination source that is lost as heat, which can further increase stability of the display device.

In some embodiments, the glass-ceramic article (e.g., optical diffuser) can comprise a haze. As used herein, haze refers to transmission haze that is measured in accordance with ASTM E430. Haze is measured using a haze meter supplied by BYK Gardner under the trademark HAZE-GUARD PLUS, using an aperture over the source port. The aperture has a diameter of 8 mm. A CIE D65 illuminant is used as the light source for illuminating the foldable apparatus. Haze is measured through a glass-ceramic article comprising a thickness of 1.2 mm. In further embodiments, the haze is measured over a range from about 2° to about 100 relative to an angle of incidence normal to the second major surface 113 of the optical diffuser 103 can be about 90% or more, about 95% or more, about 100% or more, about 150% or less, about 120% or less, about 110% or less, or about 105% or less. In further embodiments, the haze at about 0° relative to an angle of incidence normal to the second major surface 113 of the optical diffuser 103 can range from about 90% to about 150%, from about 90% to about 120%, from about 90% to about 110%, from about 90% to about 105%, from about 95% to about 105%, from about 100% to about 105%, from about 95% to about 150%, from about 100% to about 150%, from about 100% to about 120%, from about 100% to about 110%, or any range or subrange therebetween. Providing a high haze glass-ceramic article can enable a high brightness uniformity from a thin optical diffuser.

In some embodiments, the glass-ceramic article (e.g., optical diffuser) can comprise an integrated light transmission. As used herein, integrated light transmission is measured using the apparatus for measuring light transmittance described above with a reflectance disc placed over an entrance port hole of the spectrophotometer. A Spectralon SRM-99 reflectance disc was used to measure light transmittance over a wide-angle range. As above for light transmittance, the integrated light transmission is measured in the optical wavelength range from 400 nm to 700 nm by averaging measurements of for whole number wavelengths from about 400 nm to about 700 nm through a glass-ceramic article comprising a thickness of 1.2 mm. In further embodiments, the integrated light transmission can be about 40% or more, about 50% or more, about 60% or more, about 80% or less, about 70% or less, or about 60% or less. In further embodiments, the integrated light transmittance can range from about 40% to about 80%, from about 40% to about 70%, from about 40% to about 60%, from about 50% to about 60%, from about 50% to about 80%, from about 50% to about 70%, from about 60% to about 80%, from about 60% to about 70%, or any range or subrange therebetween. Providing a glass-ceramic article comprising high integrated light transmittance (e.g., about 40% or more, about 50% or more) can increase efficiently transmitting light, which can increase illumination from a display device and decrease an amount of energy from an illumination source that is lost as heat, which can further increase stability of the display device.

In some embodiments, the glass-ceramic article (e.g., optical diffuser) can comprise a color shift. As used herein, color shift is measured as 1 minus a ratio of the light transmittance measured at an optical wavelength of 600 nm to a transmittance measured at an optical wavelength of 420 nm. In further embodiments, the color shift can be about −0.1 or more, about 0 or more, about 0.1 or more, about 0.5 or less, about 0.2 or less, or about 0.1 or less. In further embodiments, the color shift can range from about −0.1 to about 0.5, from about −0.1 to about 0.2, from about 0 to about 0.2, from about 0 to about 0.1, from about 0 to about 0.5, from about 0.1 to about 0.5, from about 0.1 to about 0.2 or any range or subrange therebetween.

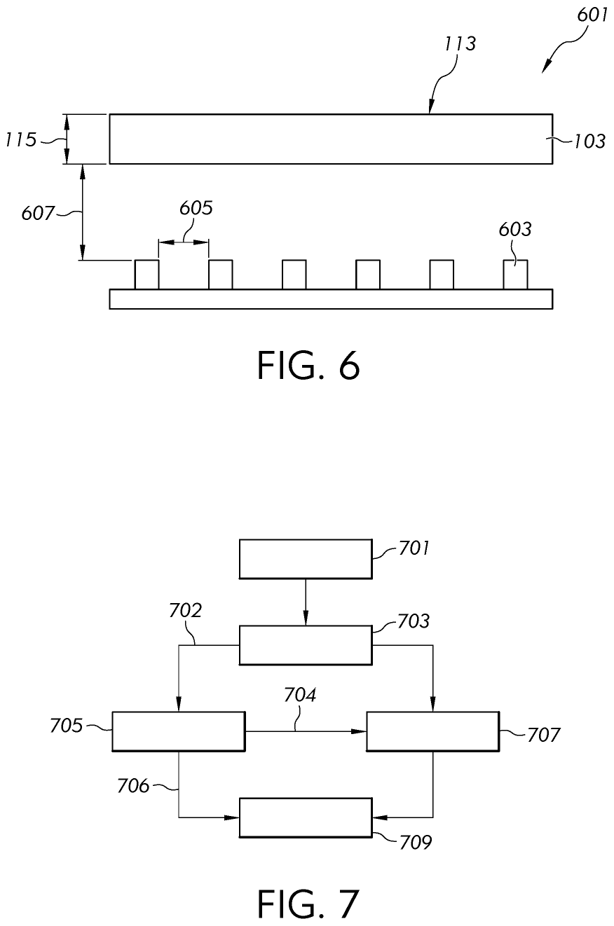

In some embodiments, the glass-ceramic article (e.g., optical diffuser) can comprise a hiding power. As used herein, hiding power is measured using the test apparatus 601 shown in FIG. 6. As shown, a series of LED light sources 603 are spaced at a predetermined pitch 605. An optical diffuser 103 to be tested comprising a thickness 115 is placed an optical distance 607 away from the LED light sources 603. The brightness intensity is measured at the second major surface 113 of the optical diffuser 103 and brightness uniformity is determined for the corresponding optical distance 607. Brightness uniformity is defined as the percentage of a minimum brightness to a maximum brightness measured in a direction of the pitch 605. The optical distance 607 is adjusted in 1 mm increments to determine the minimum optical distance where the brightness uniformity measured at the second major surface 113 of the optical diffuser 103 is 98% or more. A pitch 605 of 10 mm is used. In further embodiments, the hiding power can be about 1 mm or more, about 2 mm or more, about 5 mm or more, about 10 mm or more, about 50 mm or less, about 20 mm or less, or about 10 mm or less. In further embodiments, the hiding power can range from about 1 mm to about 50 mm, from about 1 mm to about 20 mm, from about 1 mm to about 10 mm, from about 2 mm to about 10 mm, from about 5 mm to about 10 mm, from about 2 mm to about 50 mm, from about 5 mm to about 50 mm, from about 5 mm to about 20 mm, from about 10 mm to about 20 mm, or any range or subrange therebetween.

In some embodiments, as shown in FIG. 1, the optical diffuser 103 can be incorporated into a display device 101. In further embodiments, the display device 101 can comprise a light source 105. In even further embodiments, the light source 105 can comprise a light guide plate. In even further embodiments, the light source 105 can comprise one or more of a light-emitted diode (LED), an organic light-emitting diode (OLED), a laser, a tungsten filamented bulb, or a gas filed discharge tubes including fluorescent, neon, argon, xenon, and high-energy arc discharge lamps. In even further embodiments, as shown, the first major surface 111 of the optical diffuser 103 can face the light source 105 and the second major surface 113 of the optical diffuser 103 can face the user 109. In further embodiments, the display device 101 can comprise an image display device 107. In even further embodiments, the image display device 107 can comprise a plurality of pixels. In even further embodiments, the image display device 107 can comprise a liquid crystal display (LCD). In even further embodiments, as shown, the second major surface of the optical diffuser 103 can face the display device 107. In even further embodiments, as shown, the optical diffuser 103 can be positioned between the light source 105 and the image display device 107. As shown, the light source 105 can emit light 102 towards the optical diffuser, which can increase the brightness uniformity of the emitted light 102 and transmit diffused light 104 towards the image display device 107 that can be viewed by a user 109. In some embodiments, the glass-ceramic article (e.g., optical diffuser 103) can be used in photovoltaic devices, windshields, photolithography, and imaging applications.

Embodiments of methods of making a glass-ceramic article (e.g., optical diffuser) in accordance with the embodiments of the disclosure will be discussed with reference to the flow chart in FIG. 7.

In a first step 701 of methods of making a glass-ceramic article (e.g., optical diffuser 103), methods can start with forming a mixture by melting together the components discussed above in one or more of the ranges discussed above and in Table 1.

After step 701, the methods can proceed to step 703 comprising forming a ribbon from the mixture created in step 701. In some embodiments, the ribbon can comprise a first major surface and a second major surface opposite the first major surface. In further embodiments, a thickness of the ribbon defined between the first major surface and the second major surface can be within one or more ranges for the thickness of the glass-ceramic article discussed above. In some embodiments, the ribbon can be formed by rolling. In some embodiments, the ribbon can be formed using a slot drawing technique. In some embodiments, the ribbon can be formed using a float drawing technique. In some embodiments, the ribbon can be formed by pressing the mixture into a mold.

After step 703, the methods can proceed to heating the ribbon. In some embodiments, heating the ribbon can comprise step 705 comprising heating the ribbon to a nucleation temperature for a nucleating time. Without wishing to be bound by theory, the nucleation temperature can enable nucleation of crystals and/or facilitate control of the crystal density in the resulting glass-ceramic ribbon (e.g., optical diffuser). Providing a mixture and/or composition comprising the liquidus viscosity of about 80 Pa-s or more and/or the liquidus temperature of about 1000° C. or more can facilitate processing of the mixture, composition, and/or glass-ceramic ribbon. In further embodiments, the nucleation temperature can be about 550° C. or more, about 580° C. or more, about 600° C. or more, about 650° C. or more, about 800° C. or less, about 750° C. or less, or about 700° C. or less. In further embodiments, the nucleation temperature can range from about 550° C. to about 800° C., from about 580° C. to about 800° C., from about 580° C. to about 750° C., from about 600° C. to about 750° C., from about 600° C. to about 700° C., from about 650° C. to about 700° C., from about 550° C. to about 750° C., from about 550° C. to about 700° C., or any range or subrange therebetween. In further embodiments, the nucleation time can be about 0.25 hours or more, about 0.5 hours or more, about 1 hour or more, about 2 hours or more, about 24 hours or less, about 6 hours or less, about 4 hours or less, or about 2 hours or less. In further embodiments, the nucleation time can range from about 0.25 hours to about 24 hours, from about 0.25 hours to about 6 hours, from about 0.5 hours to about 6 hours, from about 0.5 hours to about 4 hours, from about 1 hour to about 4 hours, from about 2 hours to about 4 hours, from about 0.5 hours to about 2 hours, or from about 1 hour to about 2 hours, or any range or subrange therebetween.

In some embodiments, heating the ribbon can comprise step 707 comprising heating the ribbon to a crystallization temperature for a crystallization time. In further embodiments, the methods can proceed from step 705 to step 707. In further embodiments, the methods can proceed directly from step 703 to step 707. Without wishing to be bound by theory, the crystallization temperature can facilitate crystal growth and/or the crystallization time can enable control of the grain size distribution (e.g., median grain size) of the crystals in the resulting glass-ceramic article (e.g., optical diffuser). In further embodiments, the crystallization temperature can be about 825° C. or more, about 850° C. or more, about 860° C. or more, about 900° C. or less, about 875° C. or less, or about 850° C. or less. In further embodiments, the crystallization temperature can range from about 825° C. to about 900° C., from about 825° C. to about 875° C., from about 850° C. to about 875° C., from about 850° C. to about 900° C., from about 850° C. to about 875° C., from about 860° C. to about 900° C., from about 860° C. to about 875° C., or any range or subrange therebetween. In further embodiments, the crystallization time can be about 0.25 hours or more, about 0.5 hours or more, about 1 hour or more, about 2 hours or more, about 24 hours or less, about 6 hours or less, about 4 hours or less, or about 2 hours or less. In further embodiments, the crystallization time can range from about 0.25 hours to about 24 hours, from about 0.25 hours to about 6 hours, from about 0.5 hours to about 6 hours, from about 0.5 hours to about 4 hours, from about 1 hour to about 4 hours, from about 2 hours to about 4 hours, from about 0.5 hours to about 2 hours, or from about 1 hour to about 2 hours, or any range or subrange therebetween.

In some embodiments, the methods can proceed to step 709 comprising the end of the method. In further embodiments, the result of the methods can be a glass-ceramic article. In even further embodiments, the glass-ceramic article can comprise an optical diffuser comprising the light transmittance, haze, integrated light transmission, hiding power, color shift, and/or median grain size described above. In further embodiments, step 709 can comprise assembling a display device (e.g., FIG. 1) comprising the glass-ceramic article, a light source, and an image display device. In some embodiments, the methods of making a glass-ceramic article (e.g., optical diffuser, display device) can proceed sequentially along steps 701, 703, 707, and 709 as described above, which comprises heating the ribbon to the crystallization temperature for the crystallization time without heating the ribbon to the nucleation temperature for the nucleation time. In some embodiments, arrow 702 can be followed to proceed from step 703 to step 705 comprising heating the ribbon to the nucleation temperature for the nucleation time before following arrow 704 comprising heating the ribbon to the crystallization temperature for the crystallization time. In some embodiments, arrow 702 can be followed to proceed from step 703 to step 705 comprising heating the ribbon to the nucleation temperature for the nucleation time before following arrow 706 to step 709, omitting step 707. It is to be understood that the above variations can be combined in some embodiments.

### Examples

Various embodiments will be further clarified by the following examples. Table 2 contains composition information regarding Examples A-K in mol % on an oxide basis while Table 3 contains optical properties of Examples A-K. Table 4 contains thermal treatment conditions for Examples C-K. Table 5 contains composition information of Examples 1-13 presented as mol % on an oxide basis while Table 6 contains properties of Examples 1-13.

TABLE 2
Compositions (mol %) on an oxide basis of Examples A-K

| Example | SiO₂ | Al₂O₃ | LiO₂ | Na₂O | K₂O | B₂O₃ | P₂O₅ | ZrO₂ | SnO₂ | TiO₂ | Y₂O₃ |
|---|---|---|---|---|---|---|---|---|---|---|---|
| A | 69.5 | 12.3 | 7.7 | 0.4 | 0 | 1.8 | 2.9 | 0 | 0.3 | 3.5 | 0 |
| B | 56.1 | 0 | 33.2 | 1.4 | 0 | 0 | 1.4 | 7.6 | 0 | 0 | 0.3 |
| C-J | 69.3 | 3.7 | 21.7 | 0.5 | 0.7 | 0 | 1 | 2.9 | 0.1 | 0 | 0 |
| K | 69.5 | 4.2 | 21.2 | 1.5 | 0 | 0 | 1.9 | 1.7 | 0.1 | 0 | 0 |

TABLE 3
Optical Properties of Examples A-K

| | Haze | Light |
|---|---|---|
| Example | (%) | Transmittance (%) |
| A | 99.6 | 0.06 |
| B | 100 | 6.04 |
| C | 0.1 | 91.5 |
| D | 99.7 | 45 |
| E | 102 | 53.2 |
| F | 102 | 53.6 |
| G | 102 | 55.5 |
| H | 103 | 58.9 |
| I | 102 | 52.8 |
| J | 102 | 56.5 |
| K | 101 | 53.6 |

TABLE 4
Thermal Treatment for Examples C-K

| | Nucleation | | Crystallization | |
|---|---|---|---|---|
| | Temperature | Nucleation | Temperature | Crystallization |
| Example | (° C.) | Time (h) | (° C.) | Time (h) |
| C | 580 | 4 | 740 | 1 |
| D | N/A | N/A | 860 | 2 |
| E | 700 | 1 | 875 | 4 |
| F | 725 | 1 | 875 | 4 |
| G | 750 | 1 | 875 | 4 |
| H | 580 | 4 | 860 | 4 |
| I | 700 | 4 | 860 | 4 |
| J | N/A | N/A | 860 | 4 |
| K | N/A | N/A | 850 | 0.5 |

TABLE 5
Compositions (mol %) on an oxide basis of Examples 1-13

| Example | SiO₂ | Al₂O₃ | LiO₂ | Na₂O | K₂O | B₂O₃ | P₂O₅ | ZrO₂ | SnO₂ |
|---|---|---|---|---|---|---|---|---|---|
| 1 | 69.3 | 3.7 | 21.7 | 0.5 | 0.7 | 0 | 1 | 2.9 | 0.1 |
| 2 | 69.5 | 4.2 | 21.2 | 1.5 | 0 | 0 | 1.9 | 1.7 | 0.1 |
| 3 | 68.3 | 2.7 | 21.4 | 1.9 | 0.7 | 0 | 1 | 3.9 | 0.1 |
| 4 | 68.7 | 2.7 | 21.5 | 1.5 | 0.7 | 0 | 1 | 3.9 | 0.1 |
| 5 | 69 | 2.7 | 21.6 | 1 | 0.7 | 0 | 1 | 3.9 | 0.1 |
| 6 | 69.3 | 2.7 | 21.7 | 0.5 | 0.7 | 0 | 1 | 3.9 | 0.1 |
| 7 | 68.7 | 2.7 | 22.4 | 0.5 | 0.7 | 0 | 1 | 3.9 | 0.1 |
| 8 | 68 | 2.7 | 23.2 | 0.5 | 0.7 | 0 | 1 | 3.8 | 0.1 |
| 9 | 67.4 | 2.7 | 23.9 | 0.5 | 0.7 | 0.8 | 1 | 3.8 | 0.1 |
| 10 | 71.6 | 5.7 | 17.5 | 1.5 | 0 | 0.5 | 1.2 | 1.8 | 0 |
| 11 | 71 | 5 | 19.5 | 1.5 | 0 | 0.5 | 0.8 | 1.8 | 0 |
| 12 | 70.4 | 4.9 | 19.3 | 1.5 | 0 | 0.5 | 0.8 | 2.6 | 0 |
| 13 | 69.8 | 4.9 | 19.2 | 1.5 | 0 | 0.5 | 0.8 | 3.5 | 0 |

TABLE 6
Properties of Examples 1-13

| | Liquidus | Liquidus |
|---|---|---|
| Example | Temperature (° C.) | Viscosity (Pa-s) |
| 1 | 1075 | 334.3 |
| 2 | 1030 | 503 |
| 3 | 1065 | 257.9 |
| 4 | 1080 | 218.8 |
| 5 | 1070 | 300.4 |
| 6 | 1085 | 243 |
| 7 | 1085 | 219.5 |
| 8 | 1095 | 146.6 |
| 9 | 1080 | 159.6 |
| 10 | 1070 | 980 |
| 11 | 1060 | 590 |
| 12 | 1055 | 610 |
| 13 | 1220 | 88 |

The compositions in Table 2 compare compositions within ranges discussed above for embodiments of the disclosure (e.g., Table 1) with compositions outside of those ranges. Examples C-K are within one or more ranges discussed above for embodiments of the disclosure (e.g., Table 1). Examples A-B are not within one or more of the ranges discussed above. For example, in Example A, the alumina and phosphorous pentoxide content is too high, the lithium oxide, sodium oxide, and zirconia content is too low, and it contains titanium dioxide. For example, in Example B, the lithium oxide and zirconia content is too high, the alumina content is too low, and it contains yttrium oxide.

The optical properties for Examples A-K are presented in Table 3. Example A comprises a high haze (99.6%) but a low light transmittance (0.06%). Likewise, Example B comprises a high haze (100%) but a low light transmittance (6.04%). Consequently, Examples A-B would be extremely inefficient as optical diffusers because very little light is transmitted through. In contrast, Examples E-K comprise high light transmittance (greater than 100%, e.g., from 101% to 103%) and high light transmittance (greater than 50%, e.g., from 53% to 59%). Consequently, Examples E-K have haze and light transmittance properties expected to correlate well with good hiding power and high illumination efficiency. Compared to Examples A-B, Examples E-K produce unexpected results in that the compositional difference produce both high haze and high light transmittance that is not easily achieved by Examples A-B nor expected for similar compositions.

As discussed below, the differences in thermal treatment for Examples E-K compared to Examples C-D account for the difference in optical properties. Even though Examples C-D have the same composition on an oxide basis as Examples E-K, Example C has a very low haze (0.10%) and Example D has a lower light transmittance (45%) than any of Examples E-K.

Table 4 presents the thermal treatment for Examples C-K. As discussed above, Examples E-K comprise haze values of 100% or more and light transmittance values of 50%. Examples E-K were treated with a crystallization temperature of about 850° C. or more for a crystallization time of about 0.5 hours or more. In contrast, the crystallization temperature for Example C was 740° C., which resulted in a low haze value. Without wishing to be bound by theory, providing a sufficiently high crystallization temperature can facilitate crystal growth that can enable high haze.

In some embodiments, heating the composition to a nucleation temperature for a nucleation time can simultaneously enable higher haze and higher light transmittance than if that thermal treatment was omitted. In other embodiments, as shown by Examples J-K, heating the composition to the nucleation temperature for a nucleation time can be omitted. Example H comprises the highest haze value (103%) and the highest light transmittance (58.9%) was treated at a nucleation temperature of 580° C. for a nucleation time of 4 hours. Example I was treated the same as Example H except that the nucleation temperature was 700° C. in Example I while the nucleation temperature was 580° C. in Example H, which resulted in a higher light transmittance in Example H. Consequently, decreasing the nucleation temperature from 700° C. to 580° C. can increase the light transmittance of the resulting glass-ceramic article (e.g., optical diffuser).

Table 5 presents compositions in accordance with the embodiments of the disclosure. Examples C-J in Tables 2-4 are the same as Example 1 in Table 5, and Example K in Tables 2-4 is the same as Example 2 in Table 5. While optical properties are no reported for Examples 3-13, it is expected that similar optical properties to Examples C-K would be obtained with the corresponding thermal treatment. Table 6 presents the liquidus properties, namely, liquidus temperature and liquidus viscosity for Examples 1-13. The liquidus temperatures range from 1030° C. (Example 2) to 1220° C. (Example 13). The liquidus viscosity range from 88 Pa-s (Example 13) to 980 (Example 10). As discussed above, certain components influence the liquidus viscosity while other components influence devitrification and liquidus temperature.

The schematic representation of the SEM image in FIG. 2 corresponds to Example 1 in Table 5 with a thermal treatment comprising heating the composition to a nucleation temperature of 700° C. for a nucleation time of 1 hour followed by a crystallization temperature of 860° C. for a crystallization time of 4 hours. As shown in FIG. 2, crystals 203 (e.g., ß-quartz and/or ß-spodumene crystals) can be surrounded by an amorphous glass phase 201. As shown, the crystals can comprise circular cross-sections although some crystals are in close proximity to one another, directly abut one another, and/or appear as a continuous crystal at the resolution shown in FIG. 2. A crystal grain distribution measured from the sample shown in FIG. 2 is represented in FIG. 5. As shown, the median grain size shown in FIG. 5 is about 600 nm.

The schematic representation of the SEM image in FIG. 3 corresponds to Example 2 in Table 5 with a thermal treatment comprising heating the composition to a crystallization temperature of 850° C. for a crystallization time of 0.33 hours. As shown in FIG. 3, crystals 303 (e.g., ß-quartz and/or ß-spodumene crystals) can be surrounded by an amorphous glass phase 301. As with the sample represented in FIG. 2, the crystals 303 in FIG. 3 can comprise a circular cross-section although some crystals are in close proximity to one another, directly abut one another, and/or appear as a continuous crystal at the resolution shown in FIG. 3. Compared to the crystals 203 in FIG. 2, the crystals 303 in FIG. 3 are at a higher density, and those crystals are generally smaller with a corresponding smaller grain size distribution and median grain size. This demonstrates how the thermal treatment can impact the resulting crystal structure, for example, omitting the nucleation temperature/time can result in more and smaller crystals.

An x-ray diffraction (XRD) analysis of the example corresponding to FIG. 3 is represented in FIG. 4. As shown in FIG. 4, the largest intensity peak 405 comprises ß-quartz 407 (open squares). In FIG. 4, smaller peaks 405 correspond to ß-spodumene 409 (diamonds) and lithium disilicate 411 (circles). In FIG. 4, even trace quantities of lithiophosphate 413 (triangles) are detectable. Comparing FIG. 2 to FIG. 3, the crystal grain size in FIG. 3 is smaller than in FIG. 2, which corresponds to less light scattering in the visible wavelengths and consequently lower haze.

The above disclosure provides compositions and resulting glass-ceramic articles that can provide high illumination, high brightness uniformity, thermally dimensionally stable, mechanically stable, and thin optical diffusers. The compositions of the disclosure can simultaneously provide high light transmittance (e.g., about 40% or more, from about 40% to about 70%) and high haze (e.g., about 95% or more, from about 100% to about 105%). Providing a glass-ceramic article comprising high light transmittance and high haze can act as, for example, a diffuser that increases brightness uniformity while efficiently transmitting light, which can increase illumination from a display device and decrease an amount of energy from an illumination source that is lost as heat—further increasing stability of the display device. Providing lithium disilicate crystals can increase the mechanical stability and mechanical strength of the glass-ceramic article. Further, providing substantially interlocking lithium disilicate crystals can further increase the mechanical stability and mechanical strength of the glass-ceramic article. Providing ß-spodumene or ß-quartz crystals can increase light scattering of the glass-ceramic article, which can increase the haze and hiding power of the glass-ceramic article. Further, providing crystals with a median grain size ranging from about 500 nanometers to about 1,000 nanometers (e.g., from 600 nanometers to about 800 nanometers) can increase scattering of visible light (e.g., from about 380 nanometers to about 740 nanometers, from about 400 nanometers to about 700 nanometers), which can increase the haze and hiding power of the glass-ceramic article for visible light. Formation of the above-mentioned crystals can be facilitated be providing alkali-containing aluminosilicate and/or alkali-containing aluminoborosilicate compositions comprising a high mole percent (mol %) on an oxide basis of lithium (e.g., about 17% or more, from about 20% to about 25%) and low aluminum (e.g., about 10% or less, from about 3% to about 9%). Providing a composition comprising phosphorous (e.g., from about 1 mol % to about 2 mol % on an oxide basis) can facilitate nucleation of such crystals. Heating the compositions of the embodiments of the disclosure to a crystallizing temperature ranging from about 850° C. to about 900° C. can facilitate crystal formation and controlled crystal growth. Further, prior to heating the composition to the crystallizing temperature, heating the composition to a nucleating temperature ranging from about 550° C. to about 800° C. can increase the density of crystals and/or facilitate increase control in crystal growth. Providing a composition with a liquidus viscosity of about 80 Pascal-seconds or more and/or a liquidus temperature of about 1000° C. or more can facilitate processing of the glass-ceramic article and precursors.

Directional terms as used herein—for example, up, down, right, left, front, back, top, bottom—are made only with reference to the figures as drawn and are not intended to imply absolute orientation.

It will be appreciated that the various disclosed embodiments may involve features, elements, or steps that are described in connection with that embodiment. It will also be appreciated that a feature, element, or step, although described in relation to one embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises embodiments having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. Whether or not a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint and independently of the other endpoint.

The terms “substantial,” “substantially,” and variations thereof as used herein, unless otherwise noted, are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example, within about 5% of each other, or within about 2% of each other.

Unless otherwise expressly stated, it is in no way intended that any methods set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C. As used herein, the terms “comprising” and “including”, and variations thereof shall be construed as synonymous and open-ended unless otherwise indicated.

The above embodiments, and the features of those embodiments, are exemplary and can be provided alone or in any combination with any one or more features of other embodiments provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the embodiments herein provided they come within the scope of the appended claims and their equivalents.

1. An optical diffuser comprising:
an amorphous phase; and
a crystalline phase comprising lithium disilicate and one or more of ß-spodumene or ß-quartz comprising a median grain size ranging from about 500 nanometers to about 1,000 nanometers, the crystalline phase dispersed throughout a volume of the optical diffuser,
wherein the optical diffuser comprises the following on an oxide basis in mol %:
SiO₂: 60-75;
Al₂O₃: 2-9;
Li₂O: 17-25; and
Na₂O+K₂O: 0.5-6.

2. The optical diffuser of claim 1, further comprising the following on an oxide basis in mol %:
P₂O₅: 0.5-2;
ZrO₂: 0.2-8;
B₂O₃: 0-5;
MgO+CaO+SrO: 0-5;
ZnO: 0-2; and
SnO₂: 0-2.

3. The optical diffuser of claim 2, wherein the optical diffuser comprises the following on an oxide basis in mol %:
SiO₂: 67-70;
Al₂O₃: 2.5-4.5;
LiO₂: 21-24;
Na₂O: 0.5-2;
K₂O: 0-1;
P₂O₅: 1-2;
ZrO₂: 1.5-4; and
SnO₂: 0.1.

4. The optical diffuser of claim 1, wherein ß-spodumene is predominant.

5. The optical diffuser of claim 1, wherein ß-quartz is predominant.

6. The optical diffuser of claim 1, wherein the median grain size of the one or more crystal types of the crystals ranges from about 600 nanometers to about 800 nanometers.

7. (canceled)

8. The optical diffuser of claim 1, further comprising a first major surface and a second major surface opposite the first major surface, a thickness defined between the first major surface and the second major surface ranging from about 0.5 millimeters to about 5 millimeters.

9. (canceled)

10. The optical diffuser of claim 1, wherein the optical diffuser comprises a light transmittance ranging from about 40% to about 70%.

11. (canceled)

12. The optical diffuser of claim 1, wherein the optical diffuser comprises a haze of about 95% or more.

13. (canceled)

14. The optical diffuser of claim 1, wherein the optical diffuser comprises an integrated light transmission of about 40% or more.

15. (canceled)

16. The optical diffuser of claim 1, wherein the optical diffuser comprises a hiding power of about 20 millimeters or less.

17. (canceled)

18. The optical diffuser of claim 1, wherein the optical diffuser comprises a color shift of about 0.2 or less.

19. (canceled)

20. A display device comprising:
a light source;
the optical diffuser of claim 1; and
an image display device comprising a plurality of pixels,
wherein the optical diffuser is positioned between the light source and the image display device.

21. A method of making an optical diffuser comprising:
forming a mixture by melting together the following on an oxide basis in mol %:
SiO₂: 60-75;
Al₂O₃: 2-9;
Li₂O: 17-25; and
Na₂O+K₂O: 0.5-6;
forming a ribbon from the mixture, the ribbon comprising a first major surface and a second major surface opposite the first major surface; and
heating the ribbon to a crystallizing temperature ranging from about 850° C. to about 900° C. for a crystallizing time ranging from about 0.5 hours to about 6 hours,
wherein a crystalline phase comprising lithium disilicate and one or more of ß-spodumene or ß-quartz crystals comprising a median grain size ranging from about 500 nanometers to about 1,000 nanometers is formed as a result heating the ribbon to the crystallizing temperature, the crystalline phase dispersed throughout a volume of the optical diffuser.

22. The method of claim 21, further comprising heating the ribbon to a nucleating temperature ranging from about 550° C. to about 800° C. for a nucleating time ranging from about 0.5 hours to about 6 hours before heating the ribbon to the crystallizing temperature.

23. (canceled)

24. The method of claim 21, wherein the mixture comprises a liquidus temperature ranging from about 1000° C. to about 1250° C.

25. The method of claim 21, wherein the mixture comprises a liquidus viscosity ranging from about 80 Pascal-seconds (Pa-s) to about 1,000 Pa-s.

26. (canceled)

27. The method of claim 21, wherein the mixture further comprises the following on an oxide basis in mol %:
P₂O₅: 0.5-2;
ZrO₂: 0.2-8;
B₂O₃: 0-5;
MgO+CaO+SrO: 0-5;
ZnO: 0-2; and
SnO₂: 0-2.

28. The method of claim 21, wherein the mixture comprises the following on an oxide basis in mol %:
SiO₂: 67-70;
Al₂O₃: 2.5-4.5;
LiO₂: 21-24;
Na₂O: 0.5-2;
K₂O: 0-1;
P₂O₅: 1-2;
ZrO₂: 1.5-4; and
SnO₂: 0.1.

29. The method of claim 21, wherein ß-spodumene is predominant.

30. The method of claim 21, wherein ß-quartz is predominant.

31.-37. (canceled)
